(19) United States
(12) Patent Application Publication
(10) Pub. No.: US 2016/0319120 A1
(43) Pub. Date: Nov. 3, 2016

(54) MOLDING MATERIALS BASED ON VINYL AROMATIC POLYMERS FOR 3-D-PRINTING

(71) Applicant: INEOS STYROLUTION GROUP GMBH, Frankfurt (DE)

(72) Inventors: Norbert NIESSNER, Friedelsheim (DE); Frank EISENTRAEGER, Koeln (DE)

(21) Appl. No.: 15/105,862

(22) PCT Filed: Dec. 18, 2014
(86) PCT No.: PCT/EP2014/078489

§ 371 Date: Jun. 17, 2016

(30) Foreign Application Priority Data
Dec. 18, 2013 (EP) 13198151.6

(51) Int. Cl. C08L 25/06; B33Y 50/02; B33Y 70/00; B33Y 80/00; B29C 67/00; B33Y 10/00

(52) U.S. Cl. CPC C08L 25/06; B29C 67/0055; B33Y 10/00; B33Y 70/00; B33Y 80/00; B29C 67/0088; B33Y 50/02; B29K 2025/04

(57) ABSTRACT

The invention relates to a thermoplastic molding material for 3-D printing, containing components A, B, and C: A: 40 to 100 wt % of at least one vinyl aromatic homo- or copolymer A having an average molar mass Mw of 150,000 to 360,000 g/mol, B: 0 to 60 wt % of one or more further polymers B selected from: polycarbonates, polyamides, poly(meth)acrylates, and polyesters and vinyl aromatic/diene copolymers (SBCs), C: 0 to 50 wt % of common additives and auxiliary agents, wherein the molding material has a viscosity (measured as per ISO 11443) not higher than 1×10⁵ Pa*s at shear rates of 1 to 10 1/s and at temperatures of 250° C. and a melt volume rate (MVR, measured as per ISO 1133 at 220° C. and a load of 10 kg) of more than 6 ml/10 min.

The invention relates to a thermoplastic molding composition based on vinylaromatic polymers having optimized toughness/viscosity balance and to the use thereof for 3D printing.

The use of amorphous thermoplastics for 3D printing, especially of ABS, is known. EP-A 1015215, for instance, describes a method for producing a three-dimensional object of predetermined shape from a material which can be consolidated thermally. For the 3D printing, the material is first fluidized and extruded, and two or more layers of the material are applied to a support, with movement, and then the shaped material is consolidated by cooling to below the solidification temperature of the material. Thermally consolidable material used comprises amorphous thermoplastics, especially acrylonitrile-butadiene-styrene (ABS).

EP-A 1087862 describes a rapid prototyping system for producing a three-dimensional article by extrusion and application of solidifiable thermoplastic modeling and support material in a plurality of layers. The thermoplastic material is supplied via a spool. ABS is cited as a suitable modelable material. As fragmentary support material, which is removed following completion of the 3D model, a mixture of ABS and a polystyrene copolymer as filling material with a fraction of up to 80% is used.

EP-A 1497093 describes a method for producing a prototype of a plastics injection molding from a thermoplastic material, which in fluidized form is injected into a mold until it fills the cavity of said mold and, after curing, forms the prototype. This prototype is produced via Fused Deposition Molding, a specific 3D printing method. The thermoplastic material is selected from: ABS, polycarbonate, polystyrene, acrylates, amorphous polyamides, polyesters, PPS, PPE, PEEK, PEAK, and mixtures thereof, with ABS being preferred. Contraction phenomena are avoided using preferably amorphous thermoplastics.

US 2008/0071030 describes a thermoplastic material which is used for producing three-dimensional models by multilayer deposition. The thermoplastic material comprises a base polymer selected from the group consisting of:

polyethersulfones, polyetherimides, polyphenylsulfones, polyphenylenes, polycarbonates, polysulfones, polystyrenes, acrylates, amorphous polyamides, polyesters, nylon, polyetheretherketones, and ABS, and 0.5 to 10 wt % of a silicone release agent. Preference as base polymer is given to using polyethersulfone and mixtures thereof with polystyrene (3 to 8 wt %). In order to avoid contraction, preference is given to using amorphous polymers and optionally customary filling materials.

US 2009/0295032 proposes modified ABS materials for 3D printing. The ABS materials are modified by additional monomers, oligomers or polymers, more particularly acrylates. Given as an example are MMA-modified ABS/poly(styrene-acrylonitrile) blends, more particularly CYCOLAC ABS MG 94. The proportions of the components and the viscosity of the blends are not specified.

The aforementioned materials, however, are often too brittle for 3D printing, and are deserving of improvement in relation both to toughness and to their odor. With the materials of the prior art, furthermore, the viscosity, under the conditions of the melt flow index at low shear rates, is often too high and is likewise deserving of improvement.

It is an object of the invention to provide improved, low-odor thermoplastic materials for 3-D printing with optimized toughness/viscosity balance. The object has been achieved by means of a molding composition as described below and by the use thereof for 3D printing.

The invention provides a thermoplastic molding composition for 3D printing, comprising (or consisting of) components A, B and C:

A: 40 to 100 wt % of at least one polymer A having an average molar mass Mw of 150 000 to 360 000 g/mol, selected from the group consisting of: standard polystyrene, impact-resistant polystyrene (HIPS), styrene-acrylonitrile copolymers, α-methylstyrene-acrylonitrile copolymers, styrene-maleic anhydride copolymers, styrene-phenylmaleimide copolymers, styrene-methyl methacrylate copolymers, styrene-acrylonitrile-maleic anhydride copolymers, styrene-acrylonitrile-phenylmaleimide copolymers, a-methylstyrene-acrylonitrile-methyl methacrylate copolymers, α-methylstyrene-acrylonitrile-tert-butyl methacrylate copolymers, and styrene-acrylonitrile-tert-butyl methacrylate copolymers,

where, in the high-impact polystyrene comprising polystyrene and diene rubber, the diene rubber fraction is 5 to 12 wt % and the polystyrene fraction is 88 to 95 wt % and the sum thereof makes 100 wt %;

B: 0 to 60 wt % of one or more further polymers B selected from: polycarbonates, polyamides, poly(meth)acrylates and polyesters and vinyl-aromatic-diene copolymers (SBC),

C: 0 to 50 wt % of customary additives and auxiliaries,

the fractions of A, B and C being based in each case on the overall molding composition and the sum thereof making 100 wt %,

characterized in that the viscosity (measured to ISO 11443) of the molding composition at shear rates of 1 to 10 1/s and at temperatures of 250° C. is not higher than 1×10⁵ Pa*s and the melt volume rate (MVR, measured to ISO 1133 at 220° C. and 10 kg load) is more than 6 ml/10 min.

The weight-average molar mass Mw is determined by GPC with UV detection.

For the purposes of the present invention, 3D printing means the production of three-dimensional moldings with the aid of an apparatus (3D printer) suitable for 3D printing.

In the molding composition used in accordance with the invention, the fraction of the component A is generally 40 to 100 wt %, preferably 70 to 100 wt %, more preferably 80 to 100 wt %, based on the overall molding composition.

The fraction of the component B is generally 0 to 60 wt %, preferably 0 to 30 wt %, more preferably 0 to 20 wt %, based on the overall molding composition. If polymer B is present in the molding composition, its minimum fraction is customarily 0.1 wt %.

The fraction of the additives and/or auxiliaries C is generally 0 to 50 wt %, preferably 0.1 to 30, more preferably 0.2 to 10 wt %, based on the overall molding composition. If additives and/or auxiliaries C are present in the molding composition, their minimum fraction is customarily 0.1 wt %.

Preference is given to a molding composition consisting of components A, B, and C.

With further preference, the molding composition used in accordance with the invention comprises substantially amorphous polymers, meaning that at least half (at least 50 wt %) of the polymers present in the molding composition are amorphous polymers.

Polymer A

Polymer A is preferably selected from the group consisting of: standard polystyrene, high-impact polystyrene (HIPS), styrene-acrylonitrile copolymers and α-methylstyrene-acrylonitrile copolymers.

Particularly preferred for use as polymer A is high-impact polystyrene (HIPS) and/or standard polystyrene.

High-impact polystyrenes (HIPS) and standard polystyrenes (GPPS) that are suitable as polymer A, and their production, structure and properties, are described in detail in the review literature (A. Echte, F. Haaf, J. Hambrecht in Angew. Chem. (Int. Ed. Engl.) 20, 344-361 (1981); and also in Kunststoffhandbuch, edited by R. Vieweg and G. Daumiller, volume 4 “Polystyrol”, Carl-Hanser-Verlag Munich (1996).

Furthermore, the high-impact polystyrenes used may have been structurally modified through the use of specific polybutadiene rubbers having, for example, a modified 1,4-cis and/or 1,4-trans fraction or 1,2 and 1,4 linkage fraction relative to conventional rubbers. Furthermore, in place of polybutadiene rubber, it is also possible for other diene rubbers and also elastomers of the type of ethylene-propylene-diene copolymer (EPDM rubber), and also hydrogenated diene rubbers, to be used.

In the high-impact polystyrene used as polymer A, the diene rubber fraction, more particularly the polybutadiene rubber fraction, is generally 5 to 12 wt %, preferably 6 to 10 wt %, more preferably 7 to 9 wt %, and the polystyrene fraction is generally 88 to 95 wt %, preferably 90 to 94 wt %, more preferably 91 to 93 wt %, the sum of polystyrene fraction and diene rubber fraction making 100 wt %.

Suitable standard polystyrene is produced by the method of anionic or radical polymerization. The nonuniformity of the polymer, which can be influenced by the polymerization process, is of minor importance here. Preference is given to standard polystyrene and high-impact polystyrene whose toluene-soluble fraction has an average molecular weight Mw of 150 000 to 300 000 g/mol, more preferably 150 000 to 270 000 g/mol, and which are optionally further furnished with additives, such as, for example, mineral oil (e.g., white oil), stabilizer, antistats, flame retardants or waxes.

SAN copolymers and α-methylstyrene-acrylonitrile copolymers (AMSAN) used as polymer A in accordance with the invention contain generally 18 to 35 wt %, preferably 20 to 32 wt %, more preferably 22 to 30 wt % of acrylonitrile (AN), and 82 to 65 wt %, preferably 80 to 68 wt %, more preferably 78 to 70 wt % of styrene (S) or α-methylstyrene (AMS), where the sum of styrene or α-methylstyrene and acrylonitrile makes 100 wt %.

The SAN and AMSAN copolymers used generally have an average molar mass Mw of 150 000 to 350 000 g/mol, preferably 150 000 to 300 000 g/mol, more preferably 150 000 to 250 000 g/mol, and very preferably 150 000 to 200 000 g/mol.

Suitable SAN copolymers are commercial SAN copolymers such as Luran® from Styrolution, for example. Preferred SAN copolymers are those having an S/AN ratio (in weight per cent) of 81/19 to 67/33 and a MVR (measured to ISO 1133 at 220° C. and 10 kg load) of at least 10 ml/10 min such as Luran 368, for example.

Furthermore, SMMA copolymers which can be used as polymer A in accordance with the invention contain generally 18 to 50 wt %, preferably 20 to 30 wt %, of methyl methacrylate (MMA), and 50 to 82 wt %, preferably 80 to 70 wt %, of styrene, where the sum of styrene and MMA makes 100 wt %.

Moreover, SMSA copolymers which can be used as polymer A in accordance with the invention contain generally 10 to 40 wt %, preferably 20 to 30 wt %, of maleic anhydride (MAN), and 60 to 90 wt %, preferably 80 to 70 wt %, of styrene, where the sum of styrene and MAN, makes 100 wt %.

The abovementioned polymers A have a viscosity number VN (determined to DIN 53 726 at 25° C. on a 0.5 wt % strength solution of the polymer B1 in dimethylformamide) of 50 to 120, preferably 52 to 100, and more preferably 55 to 80 ml/g. The polymers B1 are obtained in a known way by bulk, solution, suspension, precipitation or emulsion polymerization, with bulk and solution polymerization being preferred. Details of these processes are described for example in Kunststoffhandbuch, edited by R. Vieweg and G. Daumiller, volume 4 “Polystyrol”, Carl-Hanser-Verlag Munich 1996, p. 104 ff, and also in “Modern Styrenic Polymers: Polystyrenes and Styrenic Copolymers” (Eds., J. Scheirs, D. Priddy, Wiley, Chichester, UK, (2003), pages 27 to 29) and in GB-A 1472195.

Polymer B

The molding composition of the invention may further comprise at least one further polymer B selected from polycarbonates, polyamides, poly(meth)acrylates, and polyesters, and vinylaromatic-diene copolymers (SBC). It is preferable to use, as polymer B, polycarbonates, polyamides and/or poly(meth)acrylates.

Suitable polycarbonates are known per se. They are obtainable, for example, in accordance with the processes of DE-B 1 300 266, by interfacial polycondensation, or the process of DE-A 14 95 730, by reaction of biphenyl carbonate with bisphenols. A preferred bisphenol is 2,2-di(4-hydroxyphenyl)propane, referred to generally—and also below—as bisphenol A.

In place of bisphenol A it is also possible to use other aromatic dihydroxy compounds, especially 2,2-di(4-hydroxyphenyl)pentane, 2,6-dihydroxynaphthalene, 4,4′-dihydroxydiphenyl sulfone, 4,4′-dihydroxydiphenyl ether, 4,4′-dihydroxydiphenyl sulfite, 4,4′-dihydroxydiphenylmethane, 1,1-di(4-hydroxyphenyl)ethane or 4,4-dihydroxybiphenyl, and also mixtures of the aforesaid dihydroxy compounds.

Particularly preferred polycarbonates are those based on bisphenol A or bisphenol A together with up to 30 mol % of the aforementioned aromatic dihydroxy compounds.

The relative viscosity of these polycarbonates is generally in the range from 1.1 to 1.5, more particularly 1.28 to 1.4 (noted at 25° C. in a 0.5 wt % strength solution in dichloromethane).

Suitable polyesters are likewise known per se and described in the literature. They include an aromatic ring in the main chain that originates from an aromatic dicarboxylic acid. The aromatic ring may also be substituted, as for example by halogen such as chloro and bromo or by C1-C4 alkyl groups such as methyl, ethyl, isopropyl and n-propyl, and n-butyl, isobutyl, and tert-butyl groups.

The polyesters may also be prepared in a way that is known per se through reaction of aromatic dicarboxylic acids, their esters or other ester-forming derivatives thereof with aliphatic dihydroxy compounds.

Preferred dicarboxylic acids are naphthalenedicarboxylic acid, terephthalic acid, and isophthalic acid, or mixtures thereof. Up to 10 mol % of the aromatic dicarboxylic acids may be replaced by aliphatic or cycloaliphatic dicarboxylic acids such as adipic acid, azelaic acid, sebacic acid, dodecanedioic acids, and cyclohexanedicarboxylic acids.

Preferred among the aliphatic dihydroxy compounds are diols having 2 to 6 carbon atoms, especially 1,2-ethanediol, 1,4-butanediol, 1,6-hexanediol, 1,4-hexanediol, 1,4-cyclohexanediol, and neopentyl glycol, or mixtures thereof.

Particularly preferred polyesters are polyalkylene terephthalates which derive from alkanediols having 2 to 6 C atoms. Preferred especially among these are polyethylene terephthalate, polyethylene naphthalate, and polybutylene terephthalate.

The viscosity number of the polyesters is situated in general in the range from 60 to 200 ml/g (measured in a 0.5 wt % strength solution in a phenol/o-dichlorobenzene mixture (weight ratio 1:1 at 25° C.)).

Mentioned in particular as poly(meth)acrylates may be polymethyl methacrylate (PMMA) and also copolymers based on methyl methacrylate with up to 40 wt % of further copolymerizable monomers, of the kind available, for example, under the designations Lucryl® from Lucite or Plexiglas® from Evonik.

Partially crystalline, preferably linear polyamides such as polyamide 6, polyamide 6,6, polyamide 4,6, polyamide 6,12, and partially crystalline copolyamides based on these components are suitable. It is further possible to use partially crystalline polyamides whose acid component consists wholly or partly of adipic acid and/or terephthalic acid and/or isophthalic acid and/or suberic acid and/or sebacic acid and/or azelaic acid and/or dodecanedicarboxylic acid and/or a cyclohexanedicarboxylic acid, and whose diamine component consists wholly or partly in particular of m- and/or p-xylylenediamine and/or hexamethylenediamine and/or 2,2,4- and/or 2,4,4-trimethylhexamethylenediamine and/or isophoronediamine, and whose compositions are known in principle (cf. Encyclopedia of Polymers, vol. 11, p. 315 ff.).

The molecular weight Mn (number average) of the polyamides suitable as component B are preferably in the range between 5000 and 100 000, more preferably between 10 000 and 80 000.

Suitability is possessed by partially crystalline linear polyamides, for example, having a relative viscosity of 2.2 to 4.5, measured in 0.5% strength solution (0.5 g/I00 ml) in 96 wt % strength sulfuric acid at 25° C. Preferred polyamides are those deriving wholly or partly from lactams having 7 to 13 ring members, such as polycaprolactam, polycaprylyllactam or polyurolactam.

Further suitable are polyamides obtained by reacting dicarboxylic acids with one or more diamines. Examples of suitable dicarboxylic acids are alkanedicarboxylic acids having 6 to 12, especially 6 to 10, carbon atoms, especially adipic acid. Examples of suitable diamines are alkane- or cycloalkanediamines having 4 to 12, especially 4 to 8, carbon atoms; hexamethylenediamine, m-xylylenediamine, bis(4-aminophenyl)methane, bis(4-aminocyclohexyl)methane or 2,2-bis(4-aminophenyl)propane, or mixtures thereof, are particularly suitable partners for preparing such polyamides. It may be advantageous to prepare the stated polyamides per se and to use mixtures thereof.

Of particular technical significance are polyamide 6 (polycaprolactam), polyamide 6,6 (polyhexamethylene-adipamide), and polyamides composed of at least 80 wt % of repeating units of the formula —[—NH—(CH2)4-NH—CO—(CH2)4-CO—)—. The last-mentioned polyamides are obtainable by condensing 1,4-diaminobutane with adipic acid. Suitable preparation processes for polyamides are described for example in EP-A 038 094, EP-A 038 582, and EP-A 039 524.

Likewise suitable are polyamides with a small fraction, preferably up to about 10 wt %, of other cocondensable constituents, especially other amide formers such as, for example, a,w-amino acids or N-carboxylic anhydrides (Leuchs anhydrides) of amino acids.

The molding compositions of the invention may further comprise as component B a partially aromatic copolyamide with the construction described below.

Preferred partially aromatic copolyamides B contain 40 to 90 wt % of units deriving from terephthalic acid and hexamethylenediamine. A small fraction of the terephthalic acid, preferably not more than 10 wt % of the total amount of aromatic dicarboxylic acids used, may be replaced by isophthalic acid or other aromatic dicarboxylic acids, preferably those in which the carboxyl groups are in para position.

Besides the units deriving from terephthalic acid and hexamethylenediamine, the partially aromatic copolyamides contain units which derive from ε-caprolactam and/or units which derive from adipic acid and hexamethylenediamine.

The fraction of units deriving from ε-caprolactam is up to 50 wt %, preferably 20 to 50 wt %, especially 25 to 40 wt %, while the fraction of units deriving from adipic acid and hexamethylenediamine is up to 60 wt %, preferably 30 to 60 wt %, and especially 35 to 55 wt %.

The copolyamides may also contain both units of ε-caprolactam and units of adipic acid and hexamethylenediamine; in this case, the fraction of units which are free from aromatic groups is preferably at least 10 wt %, more preferably at least 20 wt %. The ratio of the units deriving from e-caprolactam and from adipic acid and hexamethylenediamine is not subject to any particular restriction here.

The melting point of particularly suitable partially aromatic copolyamides is situated for example in the range from 260 to more than 300° C., this high melting point also being associated with a high glass transition temperature of generally more than 75° C., especially more than 85° C. Binary copolyamides based on terephthalic acid, hexamethylenediamine, and ε-caprolactam, for a content of about 70 wt % of units deriving from terephthalic acid and hexamethylenediamine, have a melting point in the range of 300° C. and a glass transition temperature of more than 110° C. Binary copolyamides based on terephthalic acid, adipic acid, and hexamethylenediamine reach a melting point of 300° C. or more at a level of just about 55 wt % of units of terephthalic acid and hexamethylenediamine, with the glass transition temperature being not quite as high as for binary copolyamides which comprise ε-caprolactam in place of adipic acid or adipic acid/hexamethylenediamine.

Suitable partially aromatic copolyamides can be prepared by the processes described in EP-A 129 195 and EP-A 129 196.

In accordance with the invention, furthermore, amorphous polyamides can be used as polymer B. Based on the monomers already stated, additional monomers, frequently provided with one or more crystallization-hindering side groups, are cocondensed. As a result, the polyamide obtained is generally transparent.

Furthermore, it is possible as polymer B to use vinylaromatic-diene block copolymers (SBC), especially styrene-butadiene block copolymers. Preferred block copolymers are those comprising at least two “hard blocks” S1 and S2 (of vinylaromatic monomers) with at least one “soft block” (of dienes and optionally vinylaromatic monomers) between them, the fraction of the hard blocks being above 40 wt %, based on the overall block copolymer.

Vinylaromatics which can be used, both for the hard blocks S1 and S2 and for the soft blocks, are styrene, a-methylstyrene, p-methylstyrene, ethylstyrene, tert-butylstyrene, vinyltoluene or mixtures thereof. Styrene is preferably used.

Dienes used for the soft block B and/or B/S are preferably butadiene, isoprene, 2,3-dimethylbutadiene, 1,3-pentadiene, 1,3-hexadienes or piperylene, or mixtures thereof. Particular preference is given to using 1,3-butadiene.

The soft block is identified as B or, if formed from dienes and vinylaromatic monomers, as B/S.

Preferred block copolymers contain external hard blocks S1 and S2 with different block lengths. The molecular weight of S1 is preferably in the range from 5000 to 30 000 g/mol, more particularly in the range from 10 000 to 20 000 g/mol. The molecular weight of S2 is preferably above 35 000 g/mol. Preferred molecular weights of S2 are in the range from 50 000 to 150 000 g/mol.

Between the hard blocks S1 and S2 there may also be two or more soft blocks. Preference is given to at least 2, preferably random, soft blocks (B/S)₁ and (B/S)₂ with different fractions of vinylaromatic monomers and hence different glass transition temperatures.

The block copolymers may have a linear or a star-shaped structure.

As a linear block copolymer, preference is given to using one with the structure S1-(B/S)₁-(B/S)₂-S2. The molar ratio of vinylaromatic monomer to diene S/B in the block (B/S)₁ is preferably below 0.25 and in the block (B/S)₂ it is preferably in the range from 0.5 to 2.

Preferred star-shaped block copolymers are those with a structure comprising at least one star arm composed of the block sequence S1-(B/S) and one star arm with the block sequence S2(B/S), or those with at least one star arm of the block sequence S1-(B/S)-S3 and at least one star arm of the block sequence S2-(B/S)-S3. S3 here is a further hard block of the stated vinylaromatic monomers.

Particularly preferred are star-shaped block copolymers with structures which have at least one star arm with the block sequence SI-(B/S)₁-(B/S)₂ and at least one star arm with the block sequence S2-(B/S)₁-(B/S)₂, or which have at least one star arm with the block sequence S1-(B/S)₁-(B/S)₂-S3 and at least one star arm with the block sequence S2-(B/S)₁-(B/S)₂-S3. The molar ratio of vinylaromatic monomer to diene S/B in the outer block (B/S)₁ is preferably in the range from 0.5 to 2 and in the block (B/S)₂ it is preferably below 0.5.

The block copolymers B are prepared preferably by sequential anionic polymerization. The aforementioned SBCs are known. Their preparation is described for example in “Modern Styrenic Polymers: Polystyrenes and Styrenic Copolymers” (Eds., J. Scheirs, D. Priddy, Wiley, Chichester, UK, (2003), pages 502 to 507).

Furthermore, suitable vinylaromatic-diene block copolymers (SBC) are also, for example, available commercially as Styrolux® (manufacturer: Styrolution, Frankfurt).

Additives and/or Auxiliaries C

The molding composition of the invention may optionally comprise customary additives and/or auxiliaries C such as stabilizers, oxidation retarders, agents to counter thermal decomposition and decomposition due to ultraviolet light, lubricants and mold release agents, colorants such as dyes and pigments, fibrous and pulverulent fillers and reinforcing agents, nucleating agents, plasticizers, etc., the fraction thereof being in general not more than 50 wt %, preferably not more than 40 wt %.

Examples of oxidation retarders and heat stabilizers are halides of the metals from group I of the periodic table, examples being sodium, potassium and/or lithium halides, optionally in combination with copper(I) halides, e.g., chlorides, bromides, iodides, sterically hindered phenols, hydroquinones, different substituted representatives of these groups, and mixtures thereof, in concentrations of up to 1 wt %, based on the weight of the thermoplastic molding composition.

UV stabilizers, used generally in amounts of up to 2 wt %, based on the molding composition, include various substituted resorcinols, salicylates, benzotriazoles, and benzophenones.

Furthermore, organic dyes may be added, such as nigrosine, pigments such as titanium dioxide, phthalocyanines, ultramarine blue, and carbon black as colorants, and also fibrous and pulverulent fillers and reinforcing agents. Examples of the latter are carbon fibers, glass fibers, amorphous silica, calcium silicate (wollastonite), aluminum silicate, magnesium carbonate, kaolin, chalk, powdered quartz, mica, and feldspar. The fraction of such fillers and colorants is generally up to 50 wt %, preferably up to 35 wt %.

Examples of nucleating agents that can be used are talc, calcium chloride, sodium phenylphosphinate, aluminum oxide, silicon dioxide, and nylon 22.

Examples of lubricants and mold release agents, which can be used in general in amounts up to 1 wt %, are long-chain fatty acids such as stearic acid or behenic acid, their salts (e.g., Ca or Zn stearate) or esters (e.g., stearyl stearate or pentaerythrityl tetra-stearate), and also amide derivatives (e.g., ethylene-bisstearylamide). For better processing, mineral-based antiblocking agents may be added in amounts up to 0.1 wt % to the molding compositions of the invention. Examples include amorphous or crystalline silica, calcium carbonate, or aluminum silicate.

Processing assistants which can be used are, for example, mineral oil, preferably medical white oil, in amounts up to 5 wt %, preferably up to 2 wt %.

Examples of plasticizers include dioctyl phthalate, dibenzyl phthalate, butyl benzyl phthalate, hydrocarbon oils, N-(n-butyl)benzenesulfonamide, and o- and p-tolylethylsulfonamide.

For further improving the resistance to inflammation, it is possible to add all of the flame retardants known for the thermoplastics in question, more particularly those flame retardants based on phosphorus compounds and/or on red phosphorus itself.

The molding compositions of the invention may be produced from components a and b (and optionally further polymers B and additives and/or auxiliaries C) by all known methods.

The polymers A, where present, are mixed with the further components B and/or C in a mixing apparatus, producing a substantially liquid-melt polymer mixture.

“Substantially liquid-melt” means that the polymer mixture, as well as the predominant liquid-melt (softened) fraction, may further comprise a certain fraction of solid constituents, examples being unmelted fillers and reinforcing material such as glass fibers, metal flakes, or else unmelted pigments, colorants, etc. “Liquid-melt” means that the polymer mixture is at least of low fluidity, therefore having softened at least to an extent that it has plastic properties.

Mixing apparatuses used are those known to the skilled person. Components a and b, and—where included—B and/or C may be mixed, for example, by joint extrusion, kneading, or rolling, the aforementioned components necessarily having been isolated from the aqueous dispersion or from the aqueous solution obtained in the polymerization.

Where one or more components in the form of an aqueous dispersion or of an aqueous or nonaqueous solution are mixed in, the water and/or the solvent is removed from the mixing apparatus, preferably an extruder, via a degassing unit.

Examples of mixing apparatus for implementing the method includes discontinuously operating, heated internal kneading devices with or without RAM, continuously operating kneaders, such as continuous internal kneaders, screw kneaders with axially oscillating screws, Banbury kneaders, furthermore extruders, and also roll mills, mixing roll mills with heated rollers, and calenders.

A preferred mixing apparatus used is an extruder. Particularly suitable for melt extrusion are, for example, single-screw or twin-screw extruders. A twin-screw extruder is preferred.

In some cases the mechanical energy introduced by the mixing apparatus in the course of mixing is enough to cause the mixture to melt, meaning that the mixing apparatus does not have to be heated. Otherwise, the mixing apparatus is generally heated. The temperature is guided by the chemical and physical properties of components a and b and—when present—B and/or C, and should be selected such as to result in a substantially liquid-melt polymer mixture. On the other hand, the temperature is not to be unnecessarily high, in order to prevent thermal damage of the polymer mixture. The mechanical energy introduced may, however, also be high enough that the mixing apparatus may even require cooling. Mixing apparatus is operated customarily at 160 to 400, preferably 180 to 300° C.

Another feature of the molding composition used in accordance with the invention is that its residual monomer content is not more than 2000 ppm, preferably not more than 1000 ppm, more preferably not more than 500 ppm. Residual monomer content refers to the fraction of unreacted (uncopolymerized) monomers in the molding composition.

Furthermore, the molding composition used in accordance with the invention features a solvent content (such as the content of ethylbenzene, toluene, etc., for example) of not more than 1000 ppm, preferably not more than 500 ppm, more preferably not more than 200 ppm.

The low residual monomer content and solvent content can be obtained by employing customary methods for reducing residual monomers and solvents from polymer melts, as described for example in Kunststoffhandbuch, Eds. R. Vieweg and G. Daumiller, vol. 4 “Polystyrol”, Carl-Hanser-Verlag Munich (1996), pp. 121 to 139. In these methods, typical devolatizing apparatuses, such as, for example, partial vaporizers, flat evaporators, strand devolatilizers, thin-film evaporators or devolatilizing extruders, for example, are used.

As a result of the low residual monomer content and also solvent content, the molding composition used in accordance with the invention is low in odor and is therefore outstandingly suitable for 3D printers in the home-use segment.

Furthermore, the molding composition contains not more than 500 ppm, preferably not more than 400 ppm, more preferably not more than 300 ppm of transition metals such as Fe, Mn, and Zn, for example. Molding compositions with a low level of transition metals of this kind can be obtained, for example, by using redox initiators—if used to initiate the polymerization of the polymers present in the molding composition—only in small amounts in combination with peroxides. Furthermore, therefore, there ought to be only small amounts of transition metal-containing minerals (e.g., pigments) present in the molding composition.

In order to prevent severe contraction, the coefficient of linear thermal expansion, CLTE, of the molding composition of the invention is preferably below 100×10⁻⁶ 1/K, more preferably below 85×10⁻⁶ 1/K. A CLTE of this kind can be set through the addition of additives, more particularly minerals C, such as fibrous and pulverulent fillers and reinforcing agents and/or pigments, preferably finely divided minerals having an average particle size of <500 μm, preferably <100 μm, in amounts of 0 up to 40 wt %, based in each case on the overall molding composition.

Examples of suitable minerals (mineral additives) are carbon fibers, glass fibers, amorphous silica, calcium silicate (wollastonite), aluminum silicate, magnesium carbonate, kaolin, chalk, powdered quartz, mica, and feldspar.

According to one particular embodiment, the molding composition of the invention comprises:

40 to 100 wt % of polymer A,

0 to 60 wt % of polymer B, and

0.1 to 40 wt % of minerals C,

based in each case on the overall molding composition,

and where the sum of A, B and C is 100 wt %.

According to a further preferred embodiment, the molding composition of the invention comprises:

40 to 100 wt % of polymer A,

0 to 60 wt % of polymer B, and

0 to 40 wt % of additives and/or auxiliaries C, in particular minerals C,

based in each case on the overall molding composition,

and where the sum of A, B and C is 100 wt %.

According to a further preferred embodiment, the molding composition of the invention comprises:

40 to 99.9 wt % of polymer A,

0 to 59.9 wt % of polymer B, and

0.1 to 40 wt % of minerals C,

based in each case on the overall molding composition,

and where the sum of A, B and C is 100 wt %.

Particularly preferred is a molding composition of the invention comprising:

70 to 100 wt % of polymer A,

0 to 30 wt % of polymer B, and

0.2 to 30 wt % of minerals C.

Further particularly preferred is a molding composition of the invention comprising:

70 to 99.8 wt % of polymer A,

0 to 29.8 wt % of polymer B, and

0.2 to 30 wt % of minerals C,

based in each case on the overall molding composition,

and where the sum of A, B and C is 100 wt %.

The viscosity of the overall molding composition at shear rates of 1 to 10 1/s and at temperatures of 250° C. is not higher than 1×10⁵ Pa*s, preferably not higher than 1×10⁴ Pa*s, more preferably not higher than 1×10³ Pa*s.

The melt volume rate (MVR, measured to ISO 1133 at 220° C. and 10 kg load) is generally more than 6 ml/10 min, preferably more than 8 ml/10 min, more preferably more than 12 ml/10 min.

The aforementioned molding compositions are used in accordance with the invention for producing three-dimensional objects of predetermined shape by means of a device for 3D printing. A further subject of the invention is therefore the use of the molding compositions of the invention for 3D printing.

It is possible here to use customary apparatuses suitable for 3D printing, especially 3D printers for home use.

The three-dimensional object is generally built up under computer control from the fluidized molding composition of the invention, according to mandated dimensions and shapes (CAD).

The three-dimensional object can be produced using customary methods of 3D printing in accordance with the prior art as described for example in EP-A 1015215 and in US 2009/0295032.

Customarily, first of all, the molding composition of the invention is fluidized and extruded, a plurality of layers of the molding composition are applied to a base such as a support or to a preceding layer of the molding composition, and then the shaped material is consolidated by cooling below the solidification temperature of the molding composition.

The molding compositions of the invention exhibit an optimized toughness/viscosity balance and are therefore outstandingly suitable for 3D printing. A further advantage for the home-use sector is that the molding composition is of low odor, having only a low residual monomer content and also solvent content.

1-13. (canceled)

14. A thermoplastic molding composition for 3D printing, comprising components A, B and C:
A: 40 to 100 wt % of at least one polymer A having an average molar mass Mw of 150 000 to 360 000 g/mol,
selected from the group consisting of: standard polystyrene, impact-resistant polystyrene (HIPS), styrene-acrylonitrile copolymers, α-methylstyrene-acrylonitrile copolymers, styrene-maleic anhydride copolymers, styrene-phenylmaleimide copolymers, styrene-methyl methacrylate copolymers, styrene-acrylonitrile-maleic anhydride copolymers, styrene-acrylonitrile-phenylmaleimide copolymers, α-methylstyrene-acrylonitrile-methyl methacrylate copolymers, α-methylstyrene-acrylonitrile-tert-butyl methacrylate copolymers, and styrene-acrylonitrile-tert-butyl methacrylate copolymers, where, in the high-impact polystyrene comprising polystyrene and diene rubber, the diene rubber fraction is 5 to 12 wt % and the polystyrene fraction is 88 to 95 wt % and the sum thereof makes 100 wt %;
B: 0 to 60 wt % of one or more further polymers B selected from: polycarbonates, polyamides, poly(meth)acrylates and polyesters and vinylaromatic-diene copolymers (SBC),
C: 0 to 50 wt % of customary additives and auxiliaries,
the fractions of A, B and C being based in each case on the overall molding composition and the sum thereof making 100 wt %,
characterized in that the viscosity (measured to ISO 11443) of the molding composition at shear rates of 1 to 10 1/s and at temperatures of 250° C. is not higher than 1×105 Pa*s and the melt volume rate (MVR, measured to ISO 1133 at 220° C. and 10 kg load) is more than 6 ml/10 min.

15. The molding composition as claimed in claim 14, characterized in that at least half of the polymers present in the molding composition are amorphous polymers.

16. The molding composition as claimed in claim 14, characterized in that the polymer A polymer A used is impact-resistant polystyrene and/or standard polystyrene.

17. The molding composition as claimed in claim 14, comprising:
40 to 100 wt % of polymer A,
0 to 60 wt % of polymer B, and
0.1 to 40 wt % of minerals C.

18. The molding composition as claimed in claim 14, comprising:
70 to 100 wt % of polymer A,
0 to 30 wt % of polymer B, and
0.2 to 30 wt % of minerals C.

19. The molding composition as claimed in claim 14, characterized in that the coefficient of linear thermal expansion is less than 100×10⁻⁶ 1/K.

20. The molding composition as claimed in claim 14, characterized in that the residual monomer content is not more than 2000 ppm.

21. The molding composition as claimed in claim 14, characterized in that the solvent content is not more than 1000 ppm.

22. The molding composition as claimed in claim 14, characterized in that the transition metal content is not more than 500 ppm.

23. The molding composition as claimed in claim 14, comprising:
40 to 99.9 wt % of polymer A,
0 to 59.9 wt % of polymer B, and
0.1 to 40 wt % of minerals C.

24. The molding composition as claimed in claim 14, comprising:
70 to 99.8 wt % of polymer A,
0 to 29.8 wt % of polymer B, and
0.2 to 30 wt % of minerals C.

25. A method of 3D printing, comprising the step of extruding the molding composition as claimed in claim 14 to form an object.

26. A method of 3D printing, comprising the step of extruding the molding composition as claimed in claim 14 to form an object for home application.
